(19) United States
(12) Patent Application Publication
(10) Pub. No.: US 2017/0091818 A1
(43) Pub. Date: Mar. 30, 2017

(54) INFORMATION PROCESSING APPARATUS, CONTROL METHOD, AND RECORDING MEDIUM

(71) Applicant: LINE Corporation, Tokyo (JP)

(72) Inventor: Hiroyuki MIYAJIMA, Tokyo (JP)

(21) Appl. No.: 15/072,814

(22) Filed: Mar. 17, 2016

(30) Foreign Application Priority Data
Sep. 29, 2015 (JP) 2015-191839

(51) Int. Cl. G06Q 30/02; G06F 17/21

(52) U.S. Cl. CPC G06Q 30/0257; G06F 17/212

(57) ABSTRACT

An information processing apparatus for causing a terminal to display user-provided information items and advertisements is provided. The information processing apparatus includes a control unit configured to control the terminal to display the information items in chronological order and display the advertisements at predetermined display positions among the information items; and an obtaining unit configured to obtain operational information for the advertisements of a user of the terminal from the terminal. The control unit updates the display positions of the advertisements based on the current display positions of the advertisements and the operational information of the user.

### BACKGROUND OF THE INVENTION

1. Field of the Invention

The present invention relates to an information processing apparatus, a control method, and a recording medium, related to advertisement delivery.

2. Description of the Related Art

It has been widespread that a server delivers advertisements to terminals connected to the Internet. Further, various effective methods of delivering advertisements to terminals have been studied. For example, a method is known in which contents requested by a user of a terminal are displayed in a predetermined area of a Web page, and advertisements are displayed in an area other than the predetermined area (e.g., Patent Document 1).

In the above method of displaying advertisements, there is a problem in that the display area for the requested contents is small because the display area for the advertisements is fixed, and thus, it is difficult for the user of the terminal to browse the requested contents. Further, there is a problem in that because the display area for the advertisements is separated from the area for displaying the requested contents, the user of the terminal does not pay attention to the display area for the advertisements, and thus, sufficient advertisement effect cannot be achieved.

The present invention has been made in view of the above, and an object of the present invention is to flexibly change advertisement display positions based on the effect of the advertisements.

### CITATION LIST

### Patent Document

[Patent Document 1] Japanese Laid-Open Patent Application No. 2009-193458

### SUMMARY OF THE INVENTION

An information processing apparatus for causing a terminal to display user-provided information items and advertisements is provided. The information processing apparatus includes a control unit configured to control the terminal to display the information items in chronological order and display the advertisements at predetermined display positions among the information items; and an obtaining unit configured to obtain operational information for the advertisements by a user of the terminal from the terminal. The control unit updates the display positions of the advertisements based on the current display positions of the advertisements and the operational information of the user.

According to an aspect, it is possible to flexibly change display positions of the advertisements based on the effect of the advertisements.

Other objects, features and advantages of the present invention will become more apparent from the following detailed description when read in conjunction with the accompanying drawings.

### BRIEF DESCRIPTION OF THE DRAWINGS

FIG. 1 is a drawing illustrating an example of a structure of an information processing system according to the first embodiment.

FIG. 2 is a drawing illustrating an example of display screens of a terminal according to the first embodiment.

FIG. 3 is a drawing illustrating an example of a hardware structure of an information processing server according to the first embodiment.

FIG. 4 is a drawing illustrating an example of a functional structure of an information processing system according to the first embodiment.

FIG. 5 is a drawing illustrating a relationship between advertisements and user's operation rates stored in the storage unit according to the first embodiment.

FIG. 6 is a drawing illustrating an example of determination for updating display positions of the advertisements, according to the first embodiment.

FIG. 7 is an example of an operational sequence between an information processing server and a terminal according to the first embodiment.

FIG. 8 is an example of a flowchart illustrating operations of an information processing server according to the first embodiment.

FIG. 9 is a drawing illustrating an example (No. 1) of display screens of a terminal according to the first embodiment.

FIG. 10 is a drawing illustrating an example (No. 2) of display screens of a terminal according to the first embodiment.

### DETAILED DESCRIPTION OF THE PREFERRED EMBODIMENTS

### First Embodiment

### System Structure

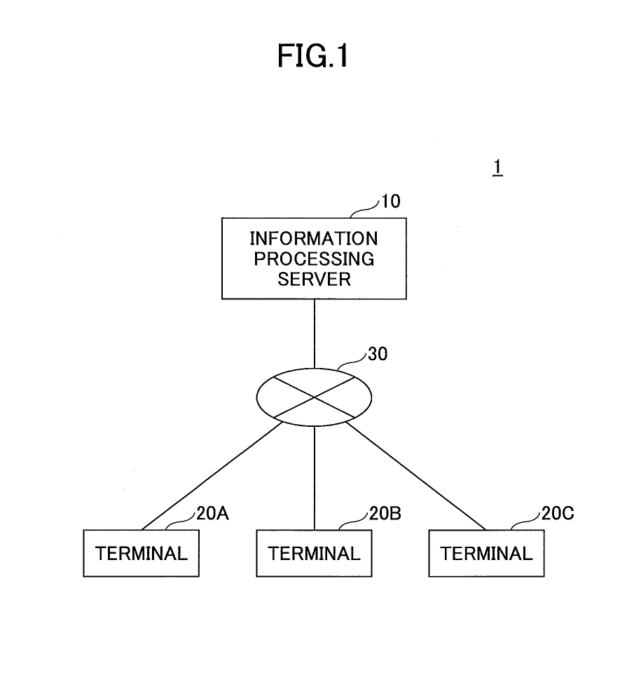

FIG. 1 is a drawing illustrating an example of an entire structure of an information processing system 1 according to a first embodiment.

The information processing system 1 includes an information processing server 10 and terminals 20. The information processing server 10 and the terminals 20 are connected to each other via a network 30. The network 30 may includes a wired network and a wireless network. The terminal 20 may be a smartphone, a tablet terminal, a notebook PC, a wearable device, or the like. A social network service (SNS) application is installed in the terminal 20, and in such an application, information items 40 provided by users of other terminals 20 (hereinafter, referred to as “user-provided information items 40”) and advertisements 50, etc., are displayed. The user-provided information items 40 includes, for example, information items of other users associated with a user of the terminal 20 via the SNS, messages posted in the SNS by the user of the terminal 20 and the other users, messages directed from the other users to the user of the terminal 20, etc.

The user-provided information items 40 are displayed in chronological order. For example, the user-provided information items 40 are displayed sequentially on the user's top screen from the top of the screen to the bottom with the latest user-provided information item 40 on top. Further, in the user-provided information items 40 displayed on a message screen, a new user-provided information item 40 is added to the bottom of the screen and displayed on the user's screen.

The information processing server 10 transmits to the terminal 20 the user-provided information items 40 related to the user of the terminal 20 and advertisements 50. The information processing server 10 transmits an instruction to the terminal 20 to display the advertisements 50 among the user-provided information items 40 that are displayed in chronological order. The instruction includes display positions of the advertisements 50.

The terminal 20 starts an SNS application, and displays the received user-provided information items 40 and advertisements 50. The terminal 20 performs a process related to the user-provided information items 40 and the advertisements 50 according to the user's operation for the user-provided information items 40 and the advertisements 50.

In the case where the terminal 20 receives the user's operation of selecting the advertisements 50, the terminal 20 transmits information related to the operation (operational information) to the information processing server 10. Further, in the case where the user keeps displaying a screen in which the advertisements 50 are shown, that is, in the case where the user does not operate to stop displaying the advertisements 50 (e.g., does not scroll the screen to stop displaying the advertisements 50), the terminal 20 transmits information related to such user's operation (operational information) to the information processing server 10. The information processing server 10 stores the received operational information of the user. It should be noted that a predetermined period used for determining that the user does not operate to stop displaying the advertisements 50 can be set arbitrarily. Relatively short periods such as one second, ten seconds, thirty seconds, one minute, etc., may be set.

The information processing server 10 updates display positions of the advertisements 50 according to the user's operation and the current display positions of the advertisements 50.

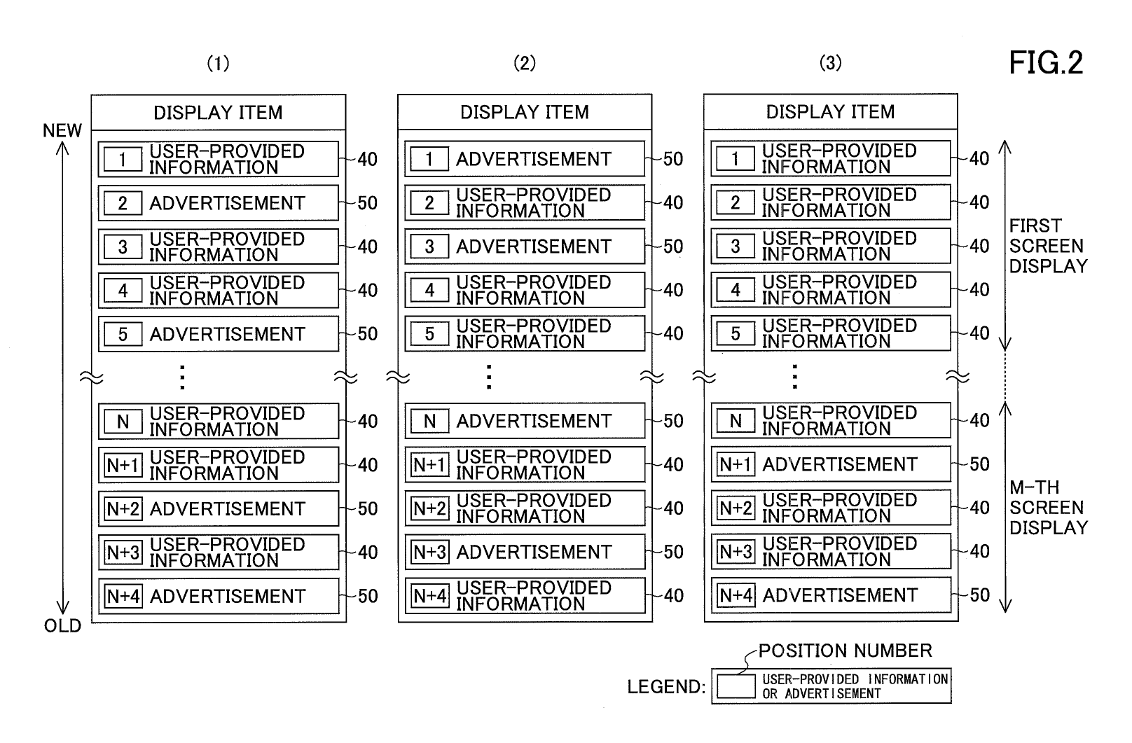

FIG. 2 is a drawing illustrating an example of display screens of a terminal 20 according to the first embodiment. When the terminal 20 receives M (M is a natural number) screens' worth of the user-provided information items 40 and the advertisements 50, the terminal 20 displays the user-provided information items 40 and the advertisements 50 according to the sequence instructed by the information processing server 10. The terminal 20 displays those user-provided information items 40 and the advertisements 50 that are set to be displayed on the first screen. When the terminal 20 receives an instruction from the user to display the second and subsequent screens, the terminal 20 displays the second and subsequent screens. When the terminal 20 receives an instruction from the user to display the (M+1)th and subsequent screens, the terminal 20 transmits to the information processing server 10 a request for transmitting the user-provided information items 40 and the advertisements 50 that should be displayed on the (M+1)th and subsequent screens. Further, the terminal 20 may receive an operation such as a scroll operation from the user of the terminal 20, and scroll the display screen. For example, in the case where the user-provided information items 40 and the advertisements 50 of position numbers 1 through 5 are displayed, upon receiving the user's operation such as a scroll operation, the terminal 20 may change the display in such a way that the user-provided information items 40 and the advertisements 50 of position numbers 2 through 6 are displayed,

The information processing server 10 determines the display positions of the advertisements 50 based on the operational information of the terminal 20, etc., and instructs the terminal 20 to display the advertisements 50.

For example, a screen (1) of FIG. 2 shows a display order in the case where the information processing server 10 instructs the terminal 20 to display the advertisements 50 at position numbers 2, 5, N+2, N+4, etc.

The display order is updated when the information processing server 10 receives an instruction from an administrator of the information processing server 10, or according to a predetermined condition. For example, the display positions of the advertisements 50 may be changed as shown in a screen (2) of FIG. 2. In the case of the screen (2) of FIG. 2, the advertisements 50 are displayed at position numbers 1, 3, N, N+3, etc.

Further, as shown in a screen (3) of FIG. 2, the information processing server 10 may determine the display order in such a way that the advertisements 50 are not displayed on the first screen. For example, the information processing server 10 may determines the display order in such a way that the advertisements 50 are not displayed near new user-provided information items 40 for a terminal 20 whose user is unlikely to select the advertisements 50.

<Hardware Structure>

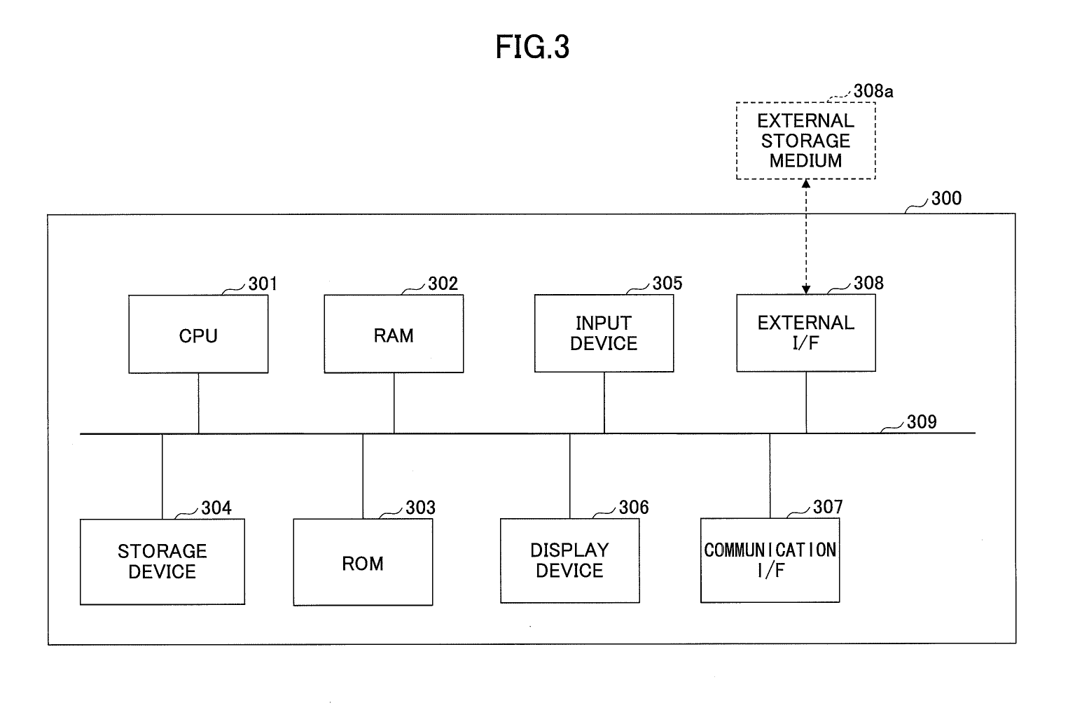

Next, a hardware structure of the information processing server 10 will be described. FIG. 3 is a drawing illustrating an example of a hardware structure of the information processing server 10 according to the first embodiment.

The information processing server 10 includes a typical computer 300. The computer 300 includes a CPU 301, a RAM 302, a ROM 303, a storage device 304, an input device 305, a display device 306, a communication interface (I/F) 307, an external I/F 308, a bus 309, etc.

The CPU 301 is an arithmetic device which realizes control and functions of the computer 300 by reading programs and data from a memory such as the ROM 303 and the storage device 304, writing them to the RAM 302, and performing processes. The ROM 303 stores programs and data such as a basic input/output system (BIOS) that is executed at the startup of the computer 300, settings of an operating system (OS), various other settings, etc. The RAM 302 is a memory which is capable of temporarily retaining programs and data. The HDD 304 is a large-capacity storage device in which programs and data are stored.

The input device 305 includes a keyboard, a mouse, and the like, and is used for a user to input operation signals. The display device 306 includes a display and the like, and displays a result of a process by the computer 300. It should be noted that the input device 305 and/or the display device 306 may take a form to be connected for use when needed.

The communication I/F 307 is an interface for connecting the computer 300 to a network 30. The external I/F 308 is an interface with an external device. The external device includes an external recording medium 308a, etc. With the above configuration, the computer 300 is capable of reading from and/or writing to the external recording medium 308a via the external I/F 308. The external recording medium 308a includes various types of optical disks, various types of memory cards, etc.

The CPU 301 reads and executes programs stored in the ROM 303, etc., and realizes functions of the information processing server 10 described later.

<Functional Structure>

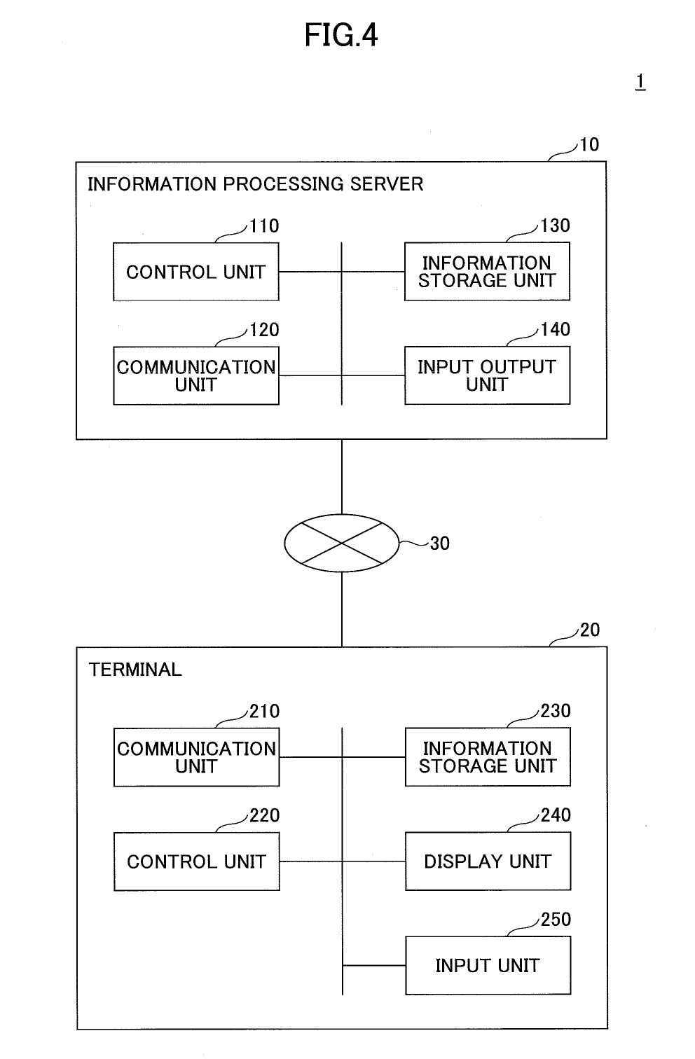

Referring to FIG. 4, functional structures of the information processing server 10 and the terminal 20 according to the first embodiment will be described. FIG. 4 is a drawing illustrating an example of a functional structure of an information processing system 1 according to the first embodiment.

(1) Information Processing Server

The information processing server 10 includes a control unit 110, a communication unit 120, an information storage unit 130, and an input and output unit 140. Functions of the information processing server 10 work together as described below.

The control unit 110 controls the terminal to display the user-provided information items 40 in chronological order as well as to display the advertisements 50 at predetermined display positions among the user-provided information items 40. The communication unit 120 receives from the terminal 20 operational information, of a user of the terminal 20, for the advertisements 50. The control unit 110 updates display positions of the advertisements 50 based on the current display positions of the advertisements 50 and the operational information of the user.

The information storage unit 130 stores the operational information of the user, etc., and the control unit 110 may refer to the operational information of the terminal 20 stored in the information storage unit 130. Specifically, the units have the following functions.

The control unit 110 transmits a signal to control an application of the terminal 20 via the communication unit 120. The control unit 110 transmits to the application of the terminal 20 user-provided information items 40 related to the user of the terminal 20 and the advertisements 50, and transmits an instruction to display the user-provided information items 40 in chronological order. The instruction includes display positions of the advertisements 50.

For example, in the case where the control unit 110 instructs the terminal 20 to display the screen as shown in a screen (1) of FIG. 2, the control unit 110 instructs the terminal 20 to display the advertisements 50 at positions of position number 2, position number 5, position number N+2, and position number N+4 (N is a natural number), etc. The control unit 110 obtains the user-provided information items 40 and the advertisements 50 for the user of the terminal 20, which are included in the instruction, from the information storage unit 130. The control unit 110 is capable of changing the display positions of the advertisements 50. For example, the control unit 110 may change the display positions of the advertisements 50 based on operation rates of the advertisements 50. For users whose operation rates of the advertisements 50 are low, the control unit 110 may not transmit an instruction to display the advertisements 50 near new user-provided information items 40, and for users whose operation rates of the advertisements 50 are high, the control unit 110 may transmit an instruction to display the advertisements 50 near new user-provided information items 40.

The sum of a number of the user-provided information items 40 and a number of the advertisements 50, which can be displayed on one screen of the terminal 20, may be limited to a predetermined number. The predetermined number is determined by a screen size of the terminal 20. Therefore, when the control unit 110 determines the display positions of the advertisements 50, the control unit 110 may determine the display positions of the advertisements 50 and the displayed contents of the advertisements 50 by taking into account the order of the screens on which the advertisements 50 are displayed.

The likelihood that the advertisements 50 displayed on the first screen are recognized by the user of the terminal 20 is high. The likelihood gradually decreases as the screen, on which the advertisements 50 are displayed, becomes the second and subsequent screens. Therefore, it is preferable that the information processing server 10 determines that the more important the advertisement 50 is, the earlier the advertisement 50 is to be displayed on the screen. Here, the important advertisement 50 is, for example, an advertisement for which the likelihood of the user of the terminal 20 being interested in is high, or an advertisement whose unit price is high.

The control unit 110 updates the display positions of the advertisements 50 based on the operational information of the user obtained during a predetermined period. The predetermined period is a period set by the administrator of the information processing server 10, and is set in units of days, units of weeks, etc. The predetermined period may be determined based on the expiration dates of the advertisements 50.

Further, the user's operational information includes information indicating that the user of the terminal 50 has performed a predetermined operation for the advertisements 50. The predetermined operation includes, for example, not only an operation of the user selecting the advertisements 50, but also a no-operation of the user not scrolling a displayed screen to remove the display of the advertisements 50 for a certain period of time (e.g., 30 seconds, 1 minutes, etc.,) and keeping on displaying the same screen of the terminal 20.

The operational information of the user for a certain period of time is stored in the information storage unit 130. The control unit 110 updates the display positions of the advertisements 50 by referring to the information stored in the information storage unit 130.

The control unit 110 stores the display positions of the advertisements 50, identifiers of the advertisements 50 displayed at corresponding positions, and fields of the advertisements 50 in the information storage unit 130, and updates the display positions of the advertisements 50 by referring to the stored information. The identifiers of the advertisements 50 are information elements for uniquely identifying the advertisements 50 and the format, etc., of the identifiers are not limited. As the fields of the advertisements 50, for example, “movie”, “men's fashion”, “lady's fashion”, “book”, “gourmet”, etc., may be set. The control unit 110 can update the display positions of the advertisements 50 based on the tendency of the user's operations related to the contents and/or the fields of the advertisements 50, by associating the user's operations with the identifiers and the fields of the advertisements 50 and storing them in the information storage unit 130.

The communication unit 120 transmits and receives a signal to and from the terminal 20. The communication unit 12 receives an instruction from the control unit 110, and transmits the user-provided information items 40 related to the user of the terminal 20, the advertisements 50, and the display positions of the advertisements 50 to the terminal 20. Further, the communication unit 120 receives from the terminal 20 the user's operational information for the advertisements 50, and transmits the information to the information storage unit 130. The information storage unit 130 stores the received operational information of the user.

The information storage unit 130 stores, for each user, the user-provided information items 40, the advertisements 50 to be displayed, and the display positions of the advertisements 50 determined by the control unit 110. The information storage unit 130 may obtain and store, for each user, the user-provided information items 40, the advertisements 50 to be displayed, etc., from another server in the information processing system 1.

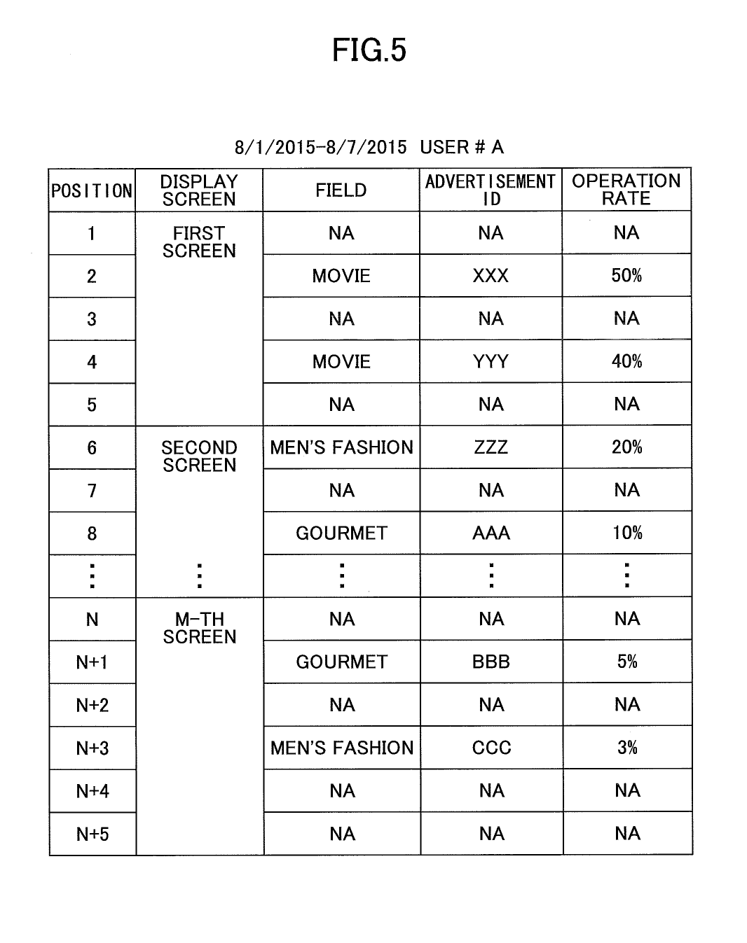

Further, the information storage unit 130 stores the user's operational information for the displayed advertisements 50. FIG. 5 is a drawing illustrating a relationship between advertisements 50 and user's operation rates stored in the storage unit 130 according to the first embodiment. FIG. 5 shows the advertisements 50 displayed by the terminal 20 of the user #A from Aug. 1, 2015 to Aug. 7, 2015 and the user's operation rates.

“Position number” is an information element indicating a display position of an advertisement 50. “Display screen” is an information element indicating the order of the screen to be displayed. “Field” is an information element indicating a field of the advertisement 50. “Advertisement ID” is an identifier of the advertisement 50. The advertisements 50 displayed in the terminal 20 of the user can be identified by the advertisement IDs. “Operation rate” is an information element indicating a ratio between a number of times the advertisement 50 is displayed and a number of times the user has performed a predetermined operation for the advertisement 50. For example, in the case where the information processing server 10 receives information indicating that an advertisement 50 #A is displayed by the terminal 20 ten times and the advertisement 50 #A has been selected three times, the “operation rate” is 30%. The “operation rate” may be stored for each type of the user operations. For example, the information storage unit 130 may store a ratio pertaining to the advertisement 50 being selected, and a ratio indicating that displaying the advertisement 50 has been maintained for a certain period of time.

“NA” shown in a table of FIG. 5 indicates that it is not the target for the information storage unit 130 to store in order to determine the display positions of the user-provide information items 40.

The information storage unit 130 calculates, for each period, the user's operation rates for the displayed advertisements 50 shown in FIG. 5, and stores the calculation results. The control unit 110 updates a display order of the advertisements 50 and the fields of the advertisements 50; a display frequency; etc., according to the operation rates in the predetermined period, and/or a tendency of the operation rates.

The input output unit 140 receives various inputs from the administrator of the information processing server 10. Further, the input output unit 140 displays a state of the information processing server 10.

(2) Terminal

The terminal 20 includes a communication unit 210, a control unit 220, an information storage unit 230, a display unit 240, and an input unit 250.

The communication unit 210 transmits and receives a signal to and from the information processing server 10. For example, the communication unit 210 receives the user-provided information items 40 of the user of the terminal 20, the advertisements 50, an instruction related to the display positions of the advertisements 50, etc. Further, the communication unit 210 receives an instruction from the control unit 220, and transmits the user's operational information for the advertisements 50 to the information processing server 10.

The control unit 220 controls various functions of the terminal 20. Further, the control unit 220 controls an application running on the terminal 20. When the communication unit 210 receives the user-provided information items 40 of the user of the terminal 20, the advertisements 50, the instruction related to the display positions of the advertisements 50, etc., the control unit 220 controls the application and causes the display unit 240 to display the user-provide information items 40 and the advertisements 50. With the process of the control unit 220, the advertisements 50 are displayed at display positions specified by the instruction of the information processing server 10.

The control unit 220 obtains information indicating that the user's predetermined operation for the advertisements 50 is performed from the input unit 250 and the display unit 240. The control unit 220 transmits the operational information including the predetermined operation to the information processing server 10 via the communication unit 210. The operational information may be transmitted every time the predetermined operation is performed by the user. Further, the operational information items may be collected in every predetermined period and transmitted together in every predetermined period. In the case where the operational information is transmitted in every predetermined period, the operational information includes a predetermined operation performed by the user in the predetermined period.

The information storage unit 230 stores the user-provided information items 40 of the user of the terminal 20 received from the information processing server 10, the advertisements 50, an instruction related to the display positions of the advertisements 50, etc. Further, the information storage unit 230 obtains and stores information indicating the user's operations from the display unit 240 and the input unit 250. The information storage unit 230 transmits the stored information to the control unit 220 in response to a request from the control unit 220.

The display unit 240 displays the user-provided information items 40 of the user of the terminal 20 received from the information processing server 10, and the advertisements 50 according to the instruction of the control unit 220.

The display unit 240 receives information indicating an operation of the user of the terminal 20 from the input unit 250, and changes the display screen according to the operation. For example, in the case where information indicating an operation of selecting the advertisements 50 is received from the input unit 250, the display unit 240 displays the advertisements 50. Further, for example, in the case where information indicating a scroll operation is received from the input unit 250, the display unit 240 scrolls the screen.

In the case where a screen displaying the advertisements 50 is maintained for a predetermined period without having, for example, a scroll operation, the display unit 240 transmits information indicating the same to the information storage unit 230.

The input unit 250 receives various inputs for the terminal 20 from the user of the terminal 20. The input unit 250 receives operations including a user's operation of selecting the advertisements 50 displayed by the display unit 240, an operation of maintaining the display screen of the advertisements 50 for more than a predetermined period of time, an operation of not displaying the advertisements 50, etc. The input unit 250 transmits the received user operation to the information storage unit 230.

<Determination of Updating the Display Positions of the Advertisements by the Control Unit>

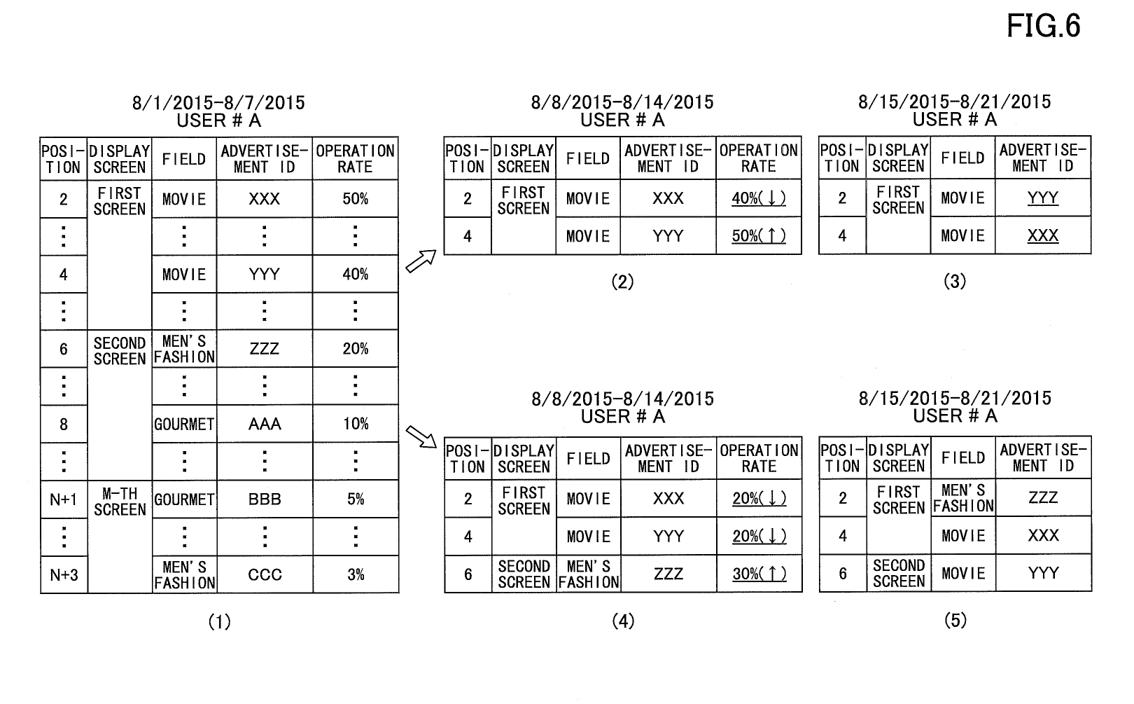

Referring to FIG. 6, determination of updating the display positions of the advertisements 50 by the control unit 110 will be described. FIG. 6 is a drawing illustrating an example of determination of updating display positions of the advertisements 50 according to the first embodiment.

FIG. 6 shows tables in which the information storage unit 130 stores the user's operation rates for the advertisements 50 every week. The format of the tables in FIG. 6 is the same as the table in FIG. 5.

It can be seen from tables (1) and (2) that the operation rate for the advertisement 50 “XXX” of the field “movie” displayed at position number 2 has decreased from 50% to 40%, and the operation rate for the advertisement 50 “YYY” of the field “movie” displayed at position number 4 has increased from 40% to 50%. Therefore, as shown in table (3) in FIG. 6, the control unit 110 may change the display position of the advertisement 50 “YYY” to position number 2 which position a user would pay more attention to, and change the display position of the advertisement 50 “XXX” to position number 4. With the above operation, display positions of the advertisements 50 in the same field can be updated. In other words, the control unit 110 may change the display positions of the advertisements 50 in such a way that the display position of a first advertisement whose operation rate is high or on an upward trend gets closer to the display position of a new user-provided information item 40 than the display position of a second advertisement whose operation rate is low or on a downward trend. Further, in the case where operation rates of multiple advertisements 50 are substantially the same, for example, in the case where an operation rate difference is 5% or less, the control unit 110 may control the display positions in such a way that the display positions of the multiple advertisements 50 are changed alternately.

In the case described above, the control unit 110 compares operation rates of the advertisements 50 of the same field, but the control unit 110 may compare operation rates of the advertisements 50 of different fields, and update the display positions in such a way that the display position of a first advertisement of the advertisements 50 whose operation rate is high or on an upward trend gets closer to the display position of a new user-provided information item 40 than the display position of a second advertisement of the advertisements 50 whose operation rate is low or on a downward trend.

Further, it can be seen from tables (1) and (4) in FIG. 6 that the operation rate for the advertisement 50 “XXX” of the field “movie” displayed at position number 2 has decreased from 50% to 20%; the operation rate for the advertisement 50 “YYY” of the field “movie” displayed at position number 4 has decreased from 40% to 20%; and the operation rate for the advertisement 50 “ZZZ” of the field “men's fashion” has increased from 20% to 30%. Therefore, as shown in table (5) in FIG. 6, the control unit 110 may change the display position of the advertisement 50 “ZZZ” to position number 2 which position a user would pay more attention to, change the display position of the advertisement 50 “XXX” to position number 4, and change the display position of the advertisement 50 “YYY” to position number 6. In other words, the control unit 110 may calculate the operation rates for all fields of the advertisements 50, and change the display positions of the advertisements 50 in such a way that the display position of an advertisement of a first field whose operation rate is high or on an upward trend gets closer to the display position of a new user-provided information item 40 than the display position of an advertisement of a second field whose operation rate is low or on a downward trend.

Further, in order to increase advertisement effects, it is preferable that an advertisement 50 whose operation rate is high be displayed on the same display screen as new user-provided information items 40 such as the latest user-provided information item 40. It is preferable that the control unit 110 update the display positions of the advertisements 50 in such a way that the display positions of the advertisements 50 whose operation rates are from the highest to the Nth highest (N is a natural number) and the display position of the latest user-provided information item 40 are included in a same screen of the terminal 20, and the advertisements 50 whose operation rates are from the highest to the Nth highest and the latest user-provided information item 40 are displayed on the same screen. In the case where the terminal 20 is a smartphone, it is preferable that a number of the advertisements 50 displayed on the same screen as the latest user-provided information item 40 be about 2 or 3 because the screen size of a smartphone is small compared to a PC, etc. In other words, it is assumed that N is set to be about 2 or 3.

In the above description, cases are described in which display positions of a part of the advertisements 50 are changed, but display positions of all of the advertisements 50 may be updated based on the tendency of the operation rates.

For example, in order to increase the likelihood that the advertisements 50 of a certain field, whose operation rate is on an upward trend, are displayed in the terminal 20, the control unit 110 may assign smaller position numbers to the advertisements 50 of the field. For example, the control unit 110 may swap the display positions of the advertisements 50 of the field “movie” to which smaller position numbers are assigned in spite of the downward tendency of the operation rates and the display positions of the advertisements 50 of the field “men's fashion” to which larger position numbers are assigned in spite of the upward tendency of the operation rates.

Further, the control unit 110 may swap the display positions of the advertisements 50 whose operation rates are lower than a predetermined expected value and the display positions of new advertisements 50. When swapping the display positions of the advertisements 50 as described above, in the case where the operation rates of the advertisements 50 of one field as a whole are decreasing, it may be assumed that the advertisements 50 of another field as a whole are the new advertisements 50. When swapping the display positions of the advertisements 50 as described above, in the case where the operation rates of the field as a whole are maintained or on an upward trend, it may be assumed that the advertisements 50 of the same field are the new advertisements 50.

Further, when updating the display positions of the advertisements 50, the control unit 110 may determine to change display positions for advertisements in the display positions. For example, in FIG. 6, the display positions for advertisement are position numbers 2, 4, 6, 8, N+1, N+3, etc., but the control unit 110 may change them to position numbers 1, 3, N, N+3, etc. For example, for a user whose operation rates of the advertisements 50 as a whole are high or on an upward trend, the control unit 110 updates the display positions in such a way that the display positions of the advertisements 50 as a whole get closer to the display positions of the new user-provided information items 40.

It should be noted that the predetermined expected value may be defined for each position number or for each display screen number. The smaller the position number is or the smaller the display screen number is, the larger is the predetermined expected value. For example, an expected value of the operation rate for the advertisements 50 at position number 1 may be set to be 50%, and an expected value of the operation rate for the advertisements 50 at position number 10 may be set to be 10%, etc. The smaller the position number or the display screen number is, the more attention can be drawn of the user of the terminal 20, and thus, the greater value is set as the expected value.

In an example of FIG. 6, it is assumed that the predetermined period is one week, and operations of the control unit 110 are described in which the control unit 110 updates the display positions of the advertisements 50 according to a trend of the operation rates per one week. However, the control unit 110 may update the display positions of the advertisements 50 at an arbitrary timing. For example, the control unit 110 may start an operation of updating the display positions of the advertisements 50 when triggered by an expiration date of the advertisements 50 displayed by the terminal 20. Further, the control unit 110 may start an operation of updating the display positions of the advertisements 50 when triggered by reversal of operation rates of a first advertisement 50 and a second advertisement 50.

<Operating Procedure>

(1) Operational Sequence

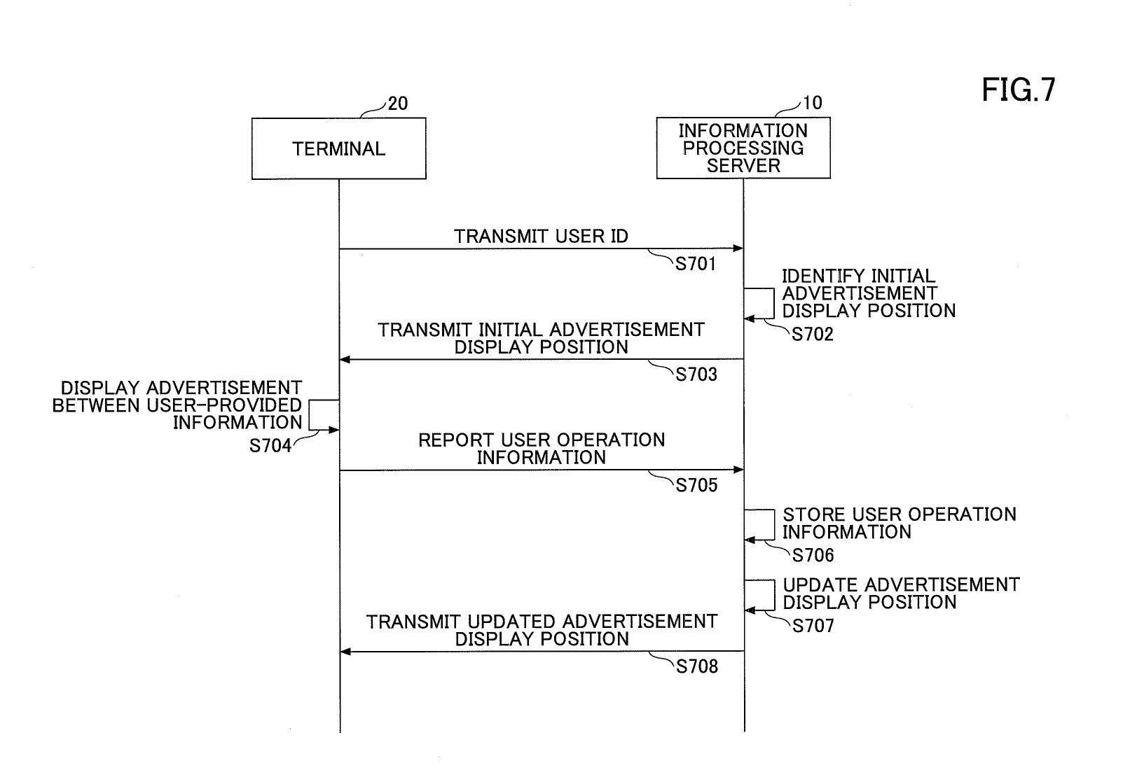

Referring to FIG. 7, an operational sequence between an information processing server 10 and a terminal 20 according to the first embodiment will be described. FIG. 7 is an example of an operational sequence between the information processing server 10 and the terminal 20 according to the first embodiment.

In step S701, the communication 210 of the terminal 20 transmits a user ID of the terminal 20 to the information processing server 10. Here, the user ID's format or the like is not limited as long as it enables the information processing server 10 to uniquely identify a user. For example, a telephone number, a user ID assigned by a provider of an SNS service, etc., may be used.

In step S702, when the communication unit 120 of the information processing server 10 obtains the user ID of the terminal 20 from the terminal 20, the control unit 110 starts an operation for determining the display positions of the advertisements 50 to be displayed in the terminal 20; the control unit 110 checks the advertisements 50 displayed for the user and the “user's operational information” related to the advertisements 50 by referring to the information storage unit 130 based on the obtained user ID; and in the case where the “user's operational information”, etc., are not stored in the information storage unit 130, the control unit 110 performs an initial setting of the display positions of the advertisements 50. When performing the initial setting, the control unit 110 may perform the initial setting of the display positions of the advertisements 50 based on the user's profile and the stored advertisements 50 displayed for another user associated with the user.

In step S703, the control unit 110 transmits a notification indicating the initial display positions of the advertisements 50 to the terminal 20 via the communication unit 120. The notification may include the advertisements 50 to be displayed. Further, the notification may be transmitted with the user-provided information items 40 related to the user of the terminal 20 and the advertisements 50.

In step S704, the communication unit 210 of the terminal 20 receives the initial display positions of the advertisements 50; the control unit 220 transmits an instruction to the display unit 240, the instruction indicating that the advertisements 50 should be displayed at the received initial positions of the advertisements 50; and the received initial display positions of the advertisements 50, etc., are stored in the information storage unit 230.

In step S705, the display unit 240 and/or the input unit 250 of the terminal 20 transmits user's operational information for the advertisements 50 to the information storage unit 230; the information storage unit 230 stores the received user's operational information; and the communication unit 210 transmits the stored user's operational information to the information processing server 10 according to an instruction from the control unit 220.

In step S706, when the communication unit 120 of the information processing server 10 receives the user's operational information, the information storage unit 130 stores the received user's operational information. In step S707, the control unit 110 updates the display positions of the advertisements 50 based on the received user's operational information and the current display positions of the advertisements 50.

In step S708, the communication unit 120 of the information processing server 10 transmits the updated display positions of the advertisements 50 to the terminal 20.

(2) Flowchart

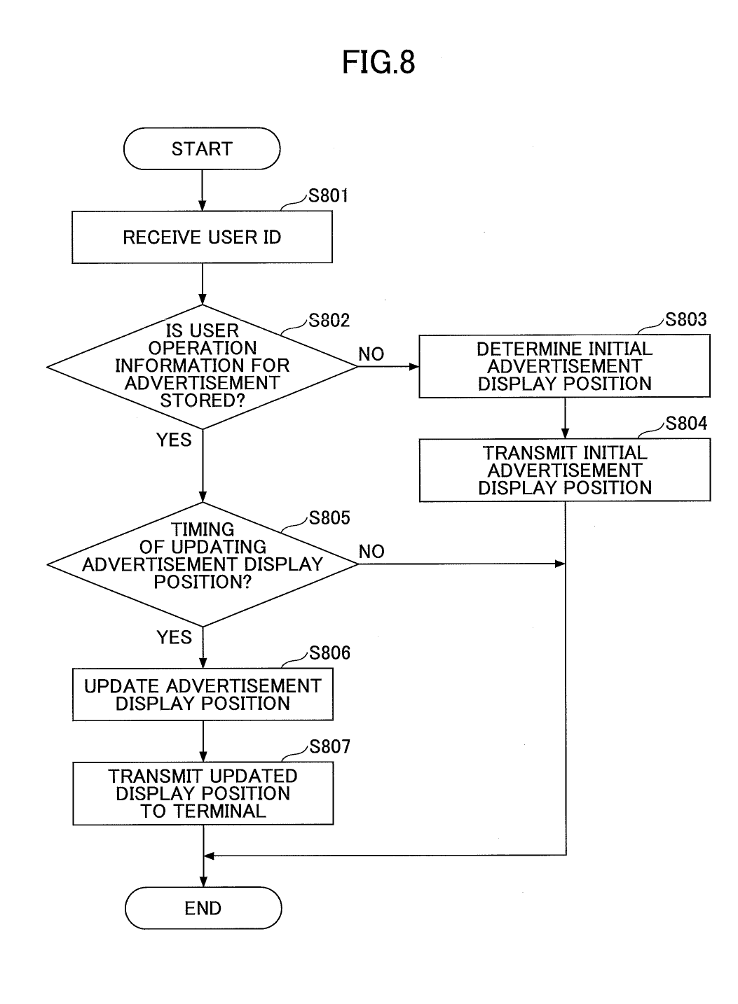

Referring to FIG. 8, a flowchart of operations of the information processing server 10 according to the first embodiment will be described. FIG. 8 is an example of a flowchart illustrating operations of the information processing server 10 according to the first embodiment.

In step S801, the communication unit 120 of the information processing server 10 receives a user ID of the terminal 20.

In step S802, referring to the information storage unit 130, the control unit 110 determines whether “user's operational information” for the advertisements 50 of the user of the terminal 20 is stored. In the case where the “user's operational information” is stored (YES in step S802), the flow goes to step S805. On the other hand, in the case where the “user's operational information” is not stored (NO in step S802), the flow goes to step S803.

In step S803, the control unit 110 performs initial setting of the display positions of the advertisements 50 and determines the initial display positions of the advertisements 50.

In step S804, the communication unit 120 transmits the initial display positions of the advertisements 50 determined by the control unit 110 to the terminal 20. After the process of step S804 is executed, operations related to the flowchart are finished.

In step S805, the control unit 110 determines whether it is a timing for updating the display positions of the advertisements 50. Update timings include a timing when a predetermined period, which can be set for each user, has elapsed; a timing when a display period of an advertisement 50 is finished; etc. In the case of the update timings (YES in step S805), the flow goes to step S806. On the other hand, in the case of no update timings (NO in step S805), processes related to the flowchart are finished.

In step S806, the control unit 110 updates the display positions of the advertisements 50 based on the current display positions of the advertisements 50 and the user's operational information for the advertisements 50 stored in the information storage unit 130.

In step S807, the communication unit 120 transmits the updated display positions of the advertisements 50 to the terminal 20 of the user. After the process of step S807 is executed, the operations related to the flowchart are finished.

<Display of Terminal>

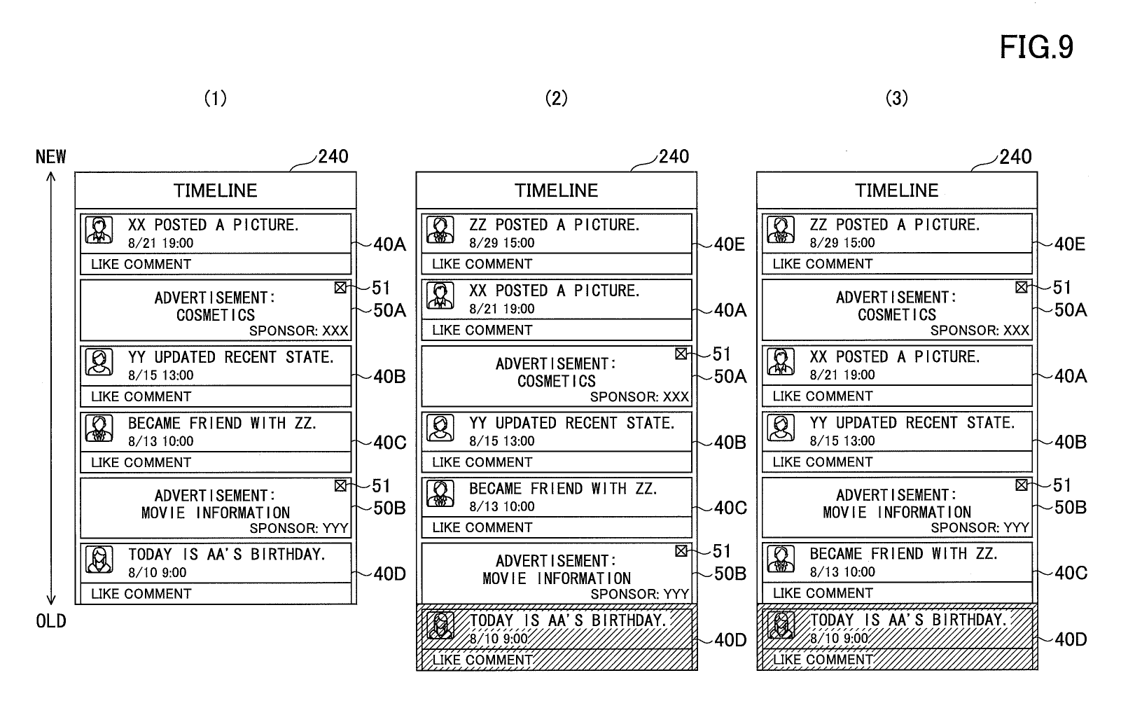

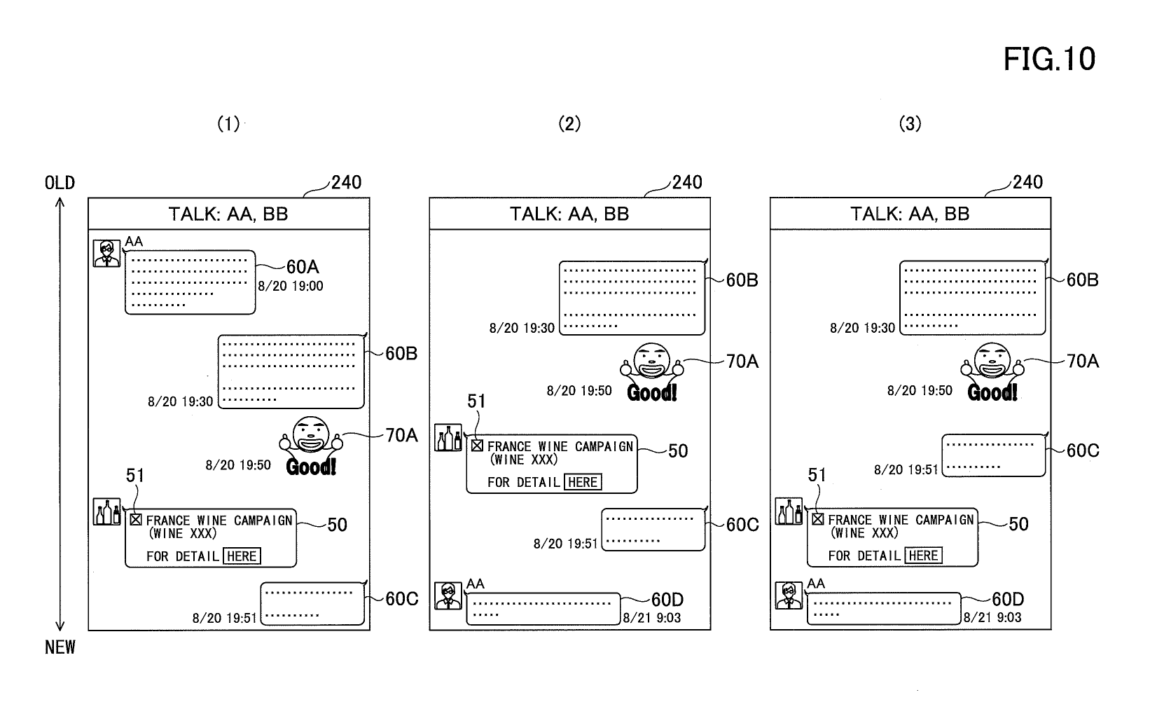

Referring to FIG. 9 and FIG. 10, a display example of the advertisements 50 on a screen of the terminal 20 will be described.

FIG. 9 is a drawing illustrating an example (No. 1) of display screens of the terminal 20 according to the first embodiment.

FIG. 9 illustrates an example of screens on which SNS posts of the user of the terminal 20 and other users related to the user are displayed in chronological order. The screens are sometimes referred to as a timeline screen. Texts, still images, moving images, etc., are displayed in posting columns.

The posts are displayed on a screen in chronological order, newer posts being displayed on the upper part of the screen and older posts being displayed on the lower part of the screen. On a screen (1) in FIG. 9, a user-provided information item 40A is the newest post, and a user-provided information item 40D is the oldest post. There is a no-display button 51 in the display of the advertisement 50. When the no-display button 51 is selected, the advertisement 50 disappears from the screen.

In the case where a new post is posted, as shown in screen (2) in FIG. 9, displayed user-provided information items 40 and the advertisements 50 are all shifted down by one line, and the user-provided information item 40D displayed in the lowest line disappears from the screen. Further, as shown in screen (3) in FIG. 9, the display positions of the advertisements 50 may be fixed, and the user-provided information items 40 alone may be shifted down by one line.

FIG. 10 is a drawing illustrating an example (No. 2) of display screens of the terminal 20 according to the first embodiment. FIG. 10 illustrates an example in which the advertisements 50 are displayed when a chat service is being provided, the chat service being for exchanging messages among the user of the terminal 20 and other users related to the user of the terminal 20 by using texts 60, illustrations 70, etc. Here, the texts 60 and the illustrations 70 are examples of the user-provided information items 40. In the above case, the control unit 110 of the information processing server 10 determines the display positions of the advertisements 50 among the texts 60 and the illustrations 70, and transmits the determined information to the terminal 20.

In an example of FIG. 10, an advertisement 50 is displayed among the illustration 70A and the texts 60 (60A, 60B, 60C). There is a no-display button 51 in the display of the advertisement 50. In this case, posts are displayed on a screen in chronological order, newer posts being displayed on the lower part of the screen and older posts being displayed on the upper part of the screen. Similar to the case of FIG. 9, in the case where a new message is exchanged, as shown in screen (2) in FIG. 10, the illustration 70A, the texts 60, and the advertisement 50 are all shifted up by one line, and the text 60A previously displayed in the upper most part disappears from the screen. Further, as shown in a screen (3) in FIG. 10, the display position of the advertisement 50 may be fixed.

<Notes>

In the embodiments, examples are described in which the advertisements 50 are displayed among the user-provide information items 40 displayed in chronological order according to an instruction from the information processing server 10. In addition to the above display methods of the advertisements 50, a display method may be added in which advertisements 50 are displayed when menu screens in an application transition from one menu screen to another, and when one menu screen is transitioned to another; the information processing server 10 may determine the display positions of the advertisements 50, display content, etc., on the transitioned screen based on the user's operational information for the advertisements 50.

The information processing server 10 is an example of an information processing apparatus. Functional units of the information processing server may be implemented on different hardware devices. In this case, the functional units implemented on different hardware devices work together to realize the function of the information processing server 10. For example, the information processing server 10 may perform the above-described operations by obtaining information from an information storage unit 130 implemented in another device.

A recording medium, in which software programs for realizing the function described in an embodiment are stored, may be supplied to the information processing server 10. In this case, a recording medium is provided. The recording medium stores a program for causing a computer to execute steps of causing a terminal to display user-provide information items in chronological order and display the advertisements at predetermined display positions among the user-provided information items; obtaining operational information for the advertisements by a user of the terminal from the terminal; and updating the display positions of the advertisements based on the current display positions of the advertisements and the operational information of the user.

Further, the embodiments are realized by having the information processing server 10 read and execute the program codes stored in the recording medium. In this case, the programs read from the recording medium realize the functions in an embodiment.

Further, a computer device reading and executing the programs alone may not realize the functions in an embodiment. A part or all of processes may be performed by an operating system (OS) running on the computer device according to instructions of the programs. Further, the functions in an embodiment may be realized by the processes.

The present invention is not limited to the specifically disclosed embodiments, and variations and modifications may be made without departing from the scope of the present invention.

The present application is based on and claims the benefit of priority of Japanese Priority Application No. 2015-191839 filed on Sep. 29, 2015, the entire contents of which are hereby incorporated herein by reference.

What is claimed is:

1. An information processing apparatus for causing a terminal to display user-provided information items and advertisements, the information processing apparatus comprising:
a control unit configured to control the terminal to display the information items in chronological order and display the advertisements at predetermined display positions among the information items; and
an obtaining unit configured to obtain operational information for the advertisements of a user of the terminal from the terminal,
wherein the control unit updates the display positions of the advertisements based on the current display positions of the advertisements and the operational information of the user.

2. The information processing apparatus according to claim 1,
wherein the operational information of the user includes information indicating whether a predetermined operation for the advertisements by the user of the terminal is performed,
wherein the control unit calculates an operation rate, the operation rate being a ratio between a number of times the advertisement is displayed and a number of times the predetermined operation for the advertisements is performed in a predetermined period, and updates display positions of the advertisements in such a way that a display position of a first advertisement an operation rate for which is high, gets closer to a display position of a new user-provided information item than a display position of a second advertisement an operation rate for which is low.

3. The information processing apparatus according to claim 2,
wherein the control unit calculates the operation rate for each field of the advertisements, and updates display positions of the advertisements in such a way that a display position of an advertisement of a first field an operation rate for which is high, gets closer to a display position of the new user-provided information item than a display position of an advertisement of a second field an operation rate for which is low.

4. The information processing apparatus according to claim 2,
wherein the control unit updates display positions of the advertisements in such a way that the advertisements, from an advertisement having the highest operation rate to an advertisement having N-th (N is a natural number) highest operation rate, and the new user-provided information are displayed on a same screen of the terminal.

5. The information processing apparatus according to claim 2,
wherein the predetermined operation is an operation for selecting the advertisements.

6. The information processing apparatus according to claim 2,
wherein the predetermined operation is an operation for continuing displaying the advertisements for a predetermined period of time or more.

7. The information processing apparatus according to claim 1,
wherein the user-provided information items are messages in a chat service.

8. A control method for causing a terminal to display user-provided information items and advertisements, the control method comprising:
controlling the terminal to display the user-provided information items in chronological order and display the advertisements at predetermined display positions among the user-provided information items;
obtaining operational information for the advertisements of a user of the terminal from the terminal; and
updating the display positions of the advertisements based on current display positions of the advertisements and the operational information of the user.

9. The control method according to claim 8,
wherein the operational information of the user includes information indicating whether a predetermined operation for the advertisements by the user of the terminal is performed,
wherein the obtaining includes calculating an operation rate, the operation rate being a ratio between a number of times the advertisement is displayed and a number of times the predetermined operation for the advertisements is performed in a predetermined period,
wherein the updating includes updating display positions of the advertisements in such a way that a display position of a first advertisement an operation rate for which is high, gets closer to a display position of a new user-provided information item than a display position of a second advertisement an operation rate for which is low.

10. The control method according to claim 9,
wherein the calculating includes calculating the operation rate for each field of the advertisements,
wherein the updating includes updating display positions of the advertisements in such a way that a display position of an advertisement of a first field an operation rate for which is high, gets closer to a display position of the new user-provided information item than a display position of an advertisement of a second field an operation rate for which is low.

11. The control method according to claim 9,
wherein the updating includes updating display positions of the advertisements in such a way that the advertisements, from an advertisement having the highest operation rate to an advertisement having N-th (N is a natural number) highest operation rate, and the new user-provided information are displayed on a same screen of the terminal.

12. The control method according to claim 9,
wherein the predetermined operation is an operation for selecting the advertisements.

13. The control method according to claim 9,
wherein the predetermined operation is an operation for keeping displaying the advertisements for a predetermined period of time or more.

14. The control method according to claim 8,
wherein the user-provided information items are messages in a chat service.

15. A recording medium having a program stored therein for causing a computer to cause a terminal to display user-provided information items and advertisements, the program having a control method comprising:
controlling the terminal to display the user-provided information items in chronological order and display the advertisements at predetermined display positions among the user-provided information items;
obtaining operational information for the advertisements of a user of the terminal from the terminal; and
updating the display positions of the advertisements based on current display positions of the advertisements and the operational information of the user.

16. The recording medium according to claim 15,
wherein the operational information of the user includes information indicating whether a predetermined operation for the advertisements by the user of the terminal is performed,
wherein the obtaining includes calculating an operation rate, the operation rate being a ratio between a number of times the advertisement is displayed and a number of times the predetermined operation for the advertisements is performed in a predetermined period,
wherein the updating includes updating display positions of the advertisements in such a way that a display position of a first advertisement an operation rate for which is high, gets closer to a display position of a new user-provided information item than a display position of a second advertisement an operation rate for which is low.

17. The recording medium according to claim 16,
wherein the calculating includes calculating the operation rate for each field of the advertisements,
wherein the updating includes updating display positions of the advertisements in such a way that a display position of an advertisement of a first field an operation rate for which is high, gets closer to a display position of the new user-provided information item than a display position of an advertisement of a second field an operation rate for which is low.

18. The recording medium according to 16,
wherein the updating includes updating display positions of the advertisements in such a way that the advertisements, from an advertisement having the highest operation rate to an advertisement having N-th (N is a natural number) highest operation rate, and the new user-provided information are displayed on a same screen of the terminal.

19. The recording medium according to claim 16,
wherein the predetermined operation is an operation for selecting the advertisements.

20. The control method according to claim 16,
wherein the predetermined operation is an operation for keeping displaying the advertisements for a predetermined period of time or more.
